(19) United States
(12) Patent Application Publication
(10) Pub. No.: US 2009/0089883 A1
(43) Pub. Date: Apr. 2, 2009

(54) Method and apparatus for controlling media content distribution

(75) Inventor: Steve Martocci, Bayshore, NY (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: Sympact Technologies LLC, Bayshore, NY (US)

(21) Appl. No.: 11/904,816

(22) Filed: Sep. 29, 2007

(51) Int. Cl. G06F 17/00

(52) U.S. Cl. 726/28; 726/26; 726/27

(57) ABSTRACT

A method and apparatus for establishing a syndication right of media content information and distributing the media content information amongst a plurality of web pages using the syndication right. The method and apparatus further includes granting the syndication right to a user, coupling with user criteria data, and authenticating a request for the media content information according to user criteria data.

### BACKGROUND OF THE INVENTION

1. Field of the Invention

Embodiments of the present invention generally relate to media content distribution. In particular, a method and apparatus for controlling media content distribution.

2. Description of the Related Art

Various types of media content (e.g., images, video, computer graphics, audio, animation, and the like) may be created and in some cases, published in numerous media outlets (e.g., Television, web pages, blogs, bulletin boards, print media, radio, and the like). For example, the media content information may be distributed via one or more communication networks, such as the Internet. Such distribution may involve a web page linking to the URL (Universal Resource Locator) or other address of the media content in order to display the media content at a computer. One or more files containing the media content information are transmitted to the computer and may be viewed as one or more images representing the media content.

Owners or creators of the media content may wish to restrict the distribution of their media content. For example, the media content may be linked to, accessed and embedded by web pages that damage the goodwill and reputation associated with the media content, the creator or the owner/organization. In some cases, the media content may be altered or mutilated into a form that is obscene, offensive or misleading as to the ownership of the media content. The media content may be used to commit fraud or piggyback off the perception and reputation associated with the media content.

For example, a charitable organization may create numerous forms of a piece of media content to denote the number of hours a person volunteered for the organization. As the person publishes his/her designated form of the media content on his/her personal web page, the charitable organization wants to prevent others from simply linking to media content from their web pages and misleading the world as to the number of hours they volunteered. The person may be technologically and/or financially unable to authenticate a request for the media content and prevent the distribution and unauthorized use of the media content.

Therefore, there is a need in the art for a method and apparatus of media content distribution that syndicates the media content amongst a plurality of web pages and authenticates requests for the media content such that the authentication is performed by a centralized computer.

### SUMMARY OF THE INVENTION

The present invention generally describes a method and apparatus for controlling the syndication of media content information. One embodiment of the present invention includes a method comprising the steps of establishing a syndication right of media content information and distributing the media content information amongst a plurality of web pages using the syndication right. The method further comprises the steps of granting the syndication right to a user, coupling with user criteria data, and authenticating a request for the media content information according to user criteria data.

Another embodiment of the present invention includes an apparatus comprising a memory having media content information and a distribution module for establishing at least one syndication right for the media content information and distributing the media content information to at least one web page using the at least one syndication right. The apparatus further comprises a filter for authenticating a request for the media content information according to the user criteria data.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is block diagram depicting an exemplary embodiment of a system in accordance with one or more embodiments of the present invention;

FIG. 2 is a flow diagram depicting an exemplary embodiment of a method for distributing media content information using the syndication right in accordance with one or more embodiments of the present invention; and

FIG. 3 is a flow diagram depicting an exemplary embodiment of a method for authenticating a request for the media content information in accordance with one or more embodiments of the present invention.

### DETAILED DESCRIPTION

The present invention includes one or more embodiments for controlling syndication of media content information. Using syndication rights, the present invention enables control over distribution or publication of the media content information. The present invention prevents an unauthorized web page from linking to or embedding the media content information, thus preserving the goodwill and authenticity of the media content information.

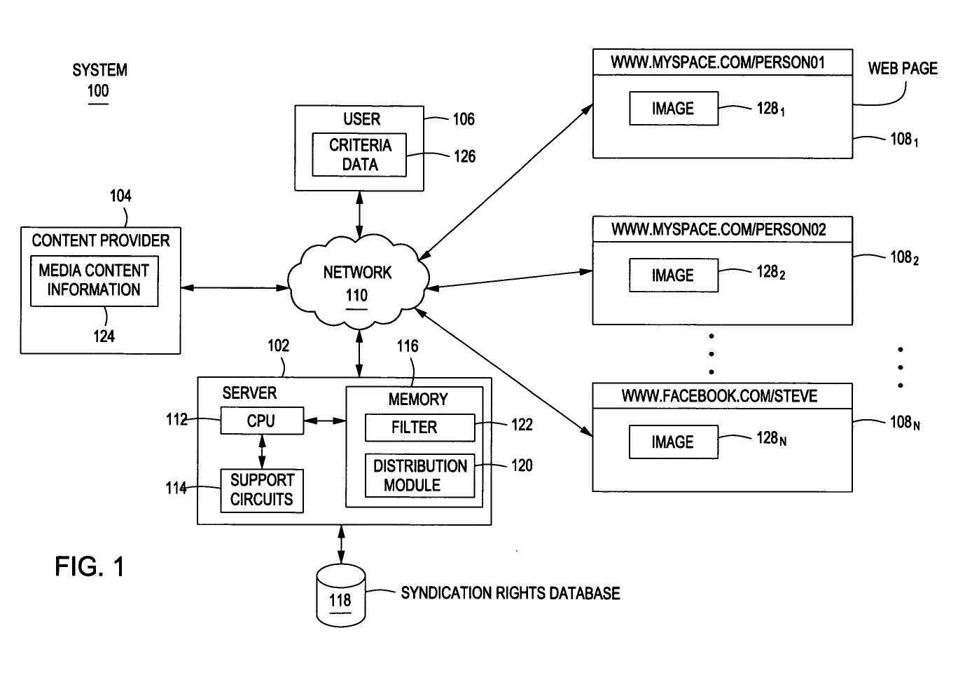

FIG. 1 is an exemplary embodiment of a system 100 in accordance with one or more embodiments of the present invention. Generally, the system 100 is a networked computer system comprising a server 102, a media content provider 104, a user 106 and web pages 108, each coupled through a network 110. The web pages 108 are illustrated as a web page 108₁, a web page 108₂ . . . a web page 108_{N}).

The network 110 comprises a communication system that connects a computer system by wire, cable, fiber optic, and/or wireless links facilitated by various types of well-known network elements, such as hubs, switches, routers, and the like. The network 110 may employ various well-known protocols to communicate information amongst the network resources. For example, the network 110 may be part of the Internet or intranet using various communications infrastructure such as Ethernet, WiFi, WiMax, GPRS, and the like.

The server 102 is a computer or a system of computers responsible for managing and distributing computer files, applications and resources to numerous devices, peripherals, computers and users within an enterprise. The server 102 comprises a central processing unit (CPU) 112, various support circuits 114, and a memory 116. In addition, the server 102 is coupled to a syndication rights database 118. In one embodiment, the server 102 accesses information regarding one or more syndication rights from the syndication rights database 118. For example, the syndication rights database 118 may provide override, parameters or rules for establishing syndications rights (e.g., provided by the content provider 104).

The CPU 112 may include one or more microprocessors known in the art. The support circuits 114, which facilitate the operation of the CPU 112, may include power supplies, clock circuits, data registers, I/O interfaces, and the like. The memory 116 may comprise random access memory, read only memory, removable memory, flash memory, and various combinations of these types of memory. The memory 116 is sometimes referred to as main memory and may in part be used as cache memory or buffer memory. The memory 116 stores various software packages including a distribution module 120 and a filter 122.

The media content provider 104 is an organization that desires to publish media content information 124 in various forms throughout the Internet or any other media outlet (e.g., radio, television, and the like). The media content information 124 may be a compressed image in a media file format such as GIF, MPEG, JPEG, AVI, and any other file format designed for graphics, photos, or video.

The user 106 is a person or an organization that acquires one or more syndication rights from the media content provider 104 through the server 102. In operation, the user 106 submits user criteria data 126 to the server 102 to control the distribution of the media content information 124 in various forms. The user criteria data 126 may include one or more domain names authorized by the user 106 to embed the media content information 124. In another embodiment, the user criteria data 126 includes one or more user names within one of the authorized domain names, where the one or more user names are also authorized to embed the media content information by the user 106.

The web pages 108 may comprise one or more hypertext documents accessible through a browser application and a communication network, such as the network 110. These documents may include graphics, text, audio, video, and the like. One may navigate through the Internet using hyperlinks within the web pages 108. It is appreciated that each of the web pages 108 are representations of the one or more hypertext documents as they are displayed at the browser application. For example, the web page 108₁ represents the display generated at the browser application of a visitor to the site WWW.MYSPACE.COM/PERSON01.

In operation, the server 102 syndicates (e.g., publishes) images 128 representing variations or modifications of an embeddable form of the media content information 124 associated with the syndication right acquired by the user 106. In one embodiment, the distribution module 120 controls the syndication of the media content information 124 through the Internet (e.g., the web pages 108) using one or more syndication rights. In one embodiment, the distribution module 120 establishes one or more syndication rights with the media content provider 104 for the media content information 124. In another embodiment, the distribution module 120 facilitates the acquisition of one or more syndication rights by the user 104. Generally, a syndication right confers the user 106 with permission to embed the media content information 124 on any of the web pages 108.

For example, if the user 106 decides to embed the media content information 124 on a first web page (e.g., the web page 108₁), then a browser application displaying the first web page may request and receive an embeddable form or variation of the media content information 124 from the server 102 (e.g., using a link on the web page). In one embodiment, when the browser application displaying the first web page requests the media content information 124, the server 102 embeds a form or a variation of the media content information. In another embodiment, the distribution module 120 cooperates with the filter 122 to publish various forms of the media content information 124 (e.g., the images 128) by authenticating requests from browser applications to embed a form of the media content information 124. In one embodiment, the filter 122 authenticates requests based on the user criteria data 126.

As another example, if the user 106 decided to embed the media content information 124 on only the first web page, then a second web page (e.g., the web page 108₂) will not receive an embeddable form or variation of the media content information 124 from the server 102. The user effectively restricted the server 102 to embedding the media content information 124 on only the first web page. The user 106 may establish the user criteria data 126 for controlling the embedding of the media content information. Optionally, one or more overrides may be employed by the server 102 to authenticate a request to view the second web page include the embeddable form of the media content information 124.

For example, the user criteria data 126 may include domain name MYSPACE and user name person01. As such, only the MYSPACE web page of PERSON01 (e.g., the web page 108₁) can link to and display the media content information 124 associated with the user 106. Moreover, if user name PERSON02 tries to link to the media content information 124 associated with the user 106, the MYSPACE web page of PERSON02 (e.g., the web page 108₂) will display nothing or an embeddable form of another media content information (e.g., an image indicating the fact that PERSON02 was not authorized by the user 106 to display or to embed the media content information 124).

According to one or more embodiments, the distribution module 120 in conjunction with the filter 122 receives a request for the media content information 124 from a browser application desiring to view a web page (e.g., the web page 108_{N}). The request may include a HTTP header having HTTP referrer information (e.g., within a HTTP referrer tag). The HTTP referrer information identifies location information (e.g., URL, IP address, domain name and the like) of the web page being viewed on the browser. The filter 122 compares a portion of the location information such as a domain name, a URL and/or a user name (e.g., FACEBOOK domain name, FACEBOOK.COM/STEVE and the like) to the user criteria data 126. If there is a match, then the user 106 desires to publish (i.e. embed) the media content information 124 on the web page. As such, each visitor to the web page is assured that the user 106 has authorized display of the media content information 124 on the web page. If there is no match, the web page is not authorized to display the media content information. The browser displays the web page without an embeddable form of the media content information 124. In one embodiment, the browser displays the web page with an image denoting the fact that the web page is not authorized to display the media content information 124.

Alternatively, a second user may strongly desire to have an embeddable form of the media content information displayed at the second web page (e.g., the web page 108₂), which has not been authorized to embed the media content information 124 by the server 102 (e.g., the domain name MYSPACE.COM and/or the user name PERSON02 are not within the user criteria data 126 and/or an override does not apply). The second user may use a proxy server to accept requests for one or more data files representing the second web page (e.g., a HTML file), rewrite (i.e. spoof) location information (e.g., within HTTP headers) within each request to indicate an authorized web page (e.g., the web page 108₁) instead of the second web page (e.g., the web page 108₂) and communicate the requests to the server 102 for authentication. The server 102 uses various proxy detection scripts to identify requests spoofed by the proxy server and deny the requests. Accordingly, an embeddable form of the media content information 124 is not communicated to the browser viewing the second web page. In one embodiment, an image (e.g., the image 128₂) indicating the fact that the second web page is not authorized to display the media content information 124 and is trying to use the proxy server to dishonestly obtain authorization from the server 102.

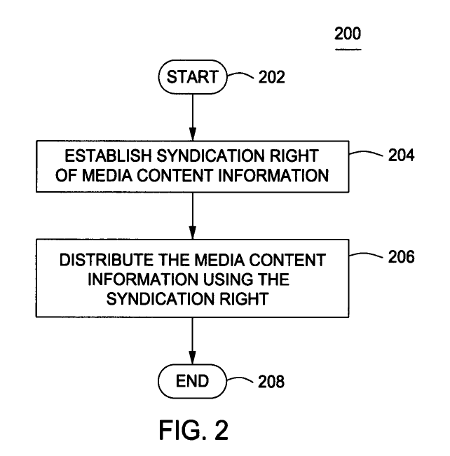

FIG. 2 is a flow diagram depicting a method 200 in accordance with one or more embodiments of the present invention. The method 200 begins at step 202 and proceeds to step 204. At step 204, one or more syndication rights are established for at least a portion of media content information. As described above, the syndication right allows one or more users to publish various forms of the media content information. In one embodiment, a media content provider is the owner and/or creator of the media content information and establishes the syndication rights in order to control distribution of the media content information.

According to one embodiment, granting the syndication right to a user includes customizing the media content information for the user. For example, the syndication right may include one or more modifications to the media content information. As another example, the user may submit one or more modifications to the media content information for generating customized media content information. In one embodiment, the user communicates a data specification to the server 102 for generating the customized media content information. The customized media content information is syndicated throughout a plurality of web pages coupled to a plurality of web domains (e.g., MYSPACE user pages stored on web servers for MYSPACE.COM).

At step 206, the media content information is distributed to the one or more web pages based on the syndication right. In one embodiment, the users may be granted a license or right to embed one or more images representing variations or modifications of the media content information on one or more web pages. User criteria data designates domain names and, in one embodiment, user names or accounts within the domain name as authorized to display a form of the media content information on their web pages. At step 208, the method 200 ends.

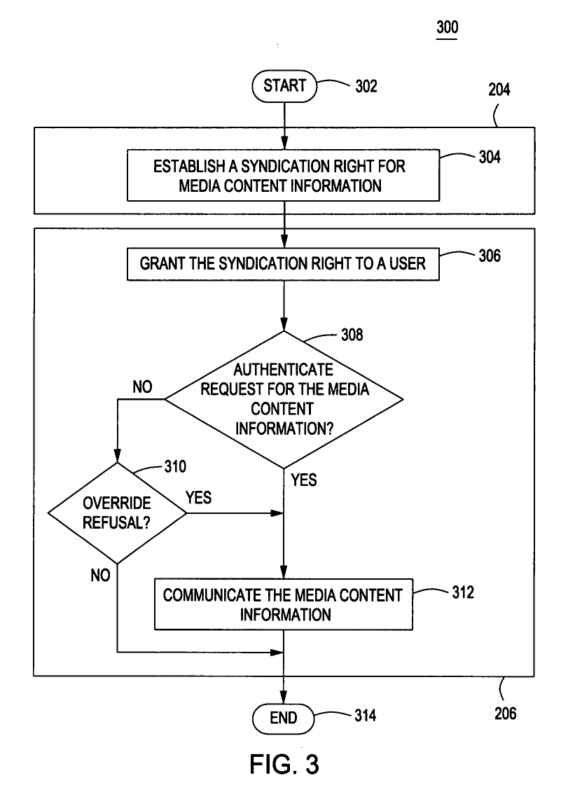

FIG. 3 is a flow diagram depicting a method 300 in accordance with one or more embodiments of the present invention. The method 300 begins at step 302. At step 304, the media content provider establishes (e.g., negotiates) one or more syndication rights for the media content information. At step 306, one of the syndication rights is granted to a user. In one embodiment, the syndication right includes one or more rules, such as which users may acquire the right to syndicate the media content information. In another embodiment, the syndication right includes one or more overrides for the user criteria data, as described above. In one embodiment, a distribution module couples with the user criteria data, which is used to further control distribution of the media content information. In one embodiment, the user criteria data includes domain names and user names authorized to display a form of the media content information.

At step 308, a determination is made as to whether a request for the media content information is from a web page authorized by the user and/or the media content provider. If the request is not from an authorized web page, then the method 300 proceeds to step 310. If the request is from an authorized web page, then the method 300 proceeds to step 312. At step 310, a determination is made as whether the unauthorized web page matches one of the overrides set by the media content provider. If there is a match, then the unauthorized web page becomes an authorized one and the method 300 proceeds to step 312. If there is no match, then the method 300 proceeds to step 314. At step 312, the media content information is communicated to the authorized web page. At step 314, the method 300 ends. In an alternative embodiment, a variation of the media content information may be communicated to the unauthorized web page that does not match any of the overrides. This variation may be an image indicating that the web page is not authorized to display the media content information.

While the foregoing is directed to embodiments of the present invention, other and further embodiments of the invention may be devised without departing from the basic scope thereof, and the scope thereof is determined by the claims that follow.

1. A method for controlling syndication of media content information, comprising:
establishing a syndication right of media content information; and
distributing the media content information amongst a plurality of web pages using the syndication right.

2. The method of claim 1, further comprising coupling with the media content information of a media content provider.

3. The method of claim 2, wherein the step of establishing the syndication right further comprises processing instructions from the media content provider for restricting distribution of the media content information.

4. The method of claim 1, wherein the step of distributing further comprising generating an image representing the media content information.

5. The method of claim 1, wherein the step of distributing the media content information further comprises authenticating a request for the media content information using the syndication right.

6. The method of claim 5, wherein the request is to embed an image representing the media content information in a web page.

7. The method of claim 5, wherein the syndication right comprises a license to embed an image representing the media content information on at least one of the plurality of web pages.

8. The method of claim 5, wherein the syndication right comprises a restriction on distribution of the media content information to at least one of the plurality of web pages.

9. The method of claim 5, wherein the step of authenticating the request further comprises comparing a domain associated with the request with a plurality of authorized domains associated with the syndication right.

10. The method of claim 1, wherein the step of distributing the media content information further comprising granting the syndication right to a user, coupling with a user criteria data and distributing the media content information according to the user criteria data.

11. The method of claim 10, wherein the step of establishing the syndication right further comprises comparing the user criteria data with predefined criteria.

12. The method of claim 11, further comprising communicating the media content information in response to the request based on an override of the predefined criteria.

13. The method of claim 1, further comprising producing a report having information pertaining to distribution of the media content information.

14. The method of claim 1, further comprising coupling with a data specification and modifying the media content information into customized media content information.

15. A method of controlling syndication of media content information, comprising:
establishing a syndication right of media content information;
granting the syndication right to a user;
coupling with user criteria data from the user;
authenticating a request to embed the media content information from a web page according to the user criteria data; and
embedding the media content information in the web page.

16. The method of claim 1, wherein the step of authenticating the request to embed the media content information further comprising:
comparing the user criteria data to the request; and
determining the request being from an authorized domain.

17. An apparatus for controlling syndication of media content information, comprising:
a memory having media content information; and
a distribution module for establishing at least one syndication right for the media content information and distributing the media content information to at least one web page using the at least one syndication right.

18. The apparatus of claim 17, wherein the at least one syndication right includes a license to embed the media content information in the at least one web page.

19. The apparatus of claim 17, wherein the distribution module couples with user criteria data and distributes the media content information in accordance with the user criteria data.

20. The apparatus of claim 17, further comprising a filter for authenticating a request for the media content information in accordance with the user criteria data.

21. The apparatus of claim 20, wherein the filter grants the request for the media content information based on an override of the user criteria.
